(19) United States
(12) Patent Application Publication
(10) Pub. No.: US 2013/0083252 A1
(43) Pub. Date: Apr. 4, 2013

(54) GESTURE RECOGNITION CAPABLE PICTURE VIDEO FRAME

(71) Applicant: David John BOYES, Roanoke, VA (US)

(72) Inventor: David John BOYES, Roanoke, VA (US)

(21) Appl. No.: 13/644,998

(22) Filed: Oct. 4, 2012

Related U.S. Application Data
(60) Provisional application No. 61/542,875, filed on Oct. 4, 2011.

(51) Int. Cl. H04N 5/44

(52) U.S. Cl. 348/734; 348/E05.096

(57) ABSTRACT

The invention is using gesture recognition technology to feed into a computer controller that will then manipulate a video image playing back on a screen, such that the video image reacts as a user would see it looking out a window.

### CROSS-REFERENCE TO RELATED APPLICATIONS

The present invention claims priority from U.S. Provisional Patent Application No. 61/542,875 filed Oct. 4, 2011, which is incorporated herein by reference.

### TECHNICAL FIELD

The present invention relates to a wall mounted image displaying a video, and in particular to a video display picture using gesture recognition to change the perspective of the image as the user moves relative to the picture.

### BACKGROUND OF THE INVENTION

As the size and cost of computer memory decreases, wall and desk mounted picture frames have become a dynamic means of displaying, not just a single picture, but a slide show of digital images. Now, with the development of relatively inexpensive flat screen televisions, virtual picture frames displaying a video image, such as fireplaces and landscapes, have also become commonplace.

The use of gesture recognition has become common in many modern devices, such as keyboards, mice, and remote controls, which use switches, location sensors, and accelerometers to recognize human gestures and turn them into computer commands. The various sensors feed multiple types of data from different types of hardware to a computer controller. However, optical 3D gesture recognition systems use only light to determine what a user is doing and/or what the user wants. Soon, gesture recognition systems will become a common tool in our everyday lives in ways we can only imagine, due in large part, because of their simplicity.

The first generation of gesture-recognition systems worked much like human 3D recognition in nature, i.e. a light source, such as the sun, bathes an object in a full spectrum of light, and the eyes sense reflected light, but only in a limited portion of the spectrum. The brain compares a series of these reflections and computes movement and relative location.

Taking the video image one step further, video display windows, such as those disclosed in the Nintendo® Winscape® system or in a paper disclosed in the 8^{th} Annual International Workshop on Presence (PRESENCE 2005) entitled “Creating a Virtual Window using Image Based Rendering” by Weikop et al, use a tracking system that detects the position of a sensor mounted on a user as the user moves about the room to adjust the image on the display screen. Unfortunately, these prior art video display pictures require a separate sensor for the user, which ruins the illusion of the virtual image. Moreover, the sensor can be damaged, lost or easily transported to other locations, rendering the system ineffective.

An object of the present invention is to overcome the shortcomings of the prior art by providing a video display picture that eliminates the need for a separate sensor for tracking by the sensor system, whereby a user within the range of the tracking system can cause the image to be altered based on the user's position.

### SUMMARY OF THE INVENTION

Accordingly, the present invention relates to s gesture recognition video display device comprising:

a video monitor for displaying a video image;

a light source for launching a beam of light at a predetermined wavelength defining a zone of illumination;

a light detector for receiving light at the predetermined wavelength reflected from a first viewer within the zone of illumination, and for generating electrical signals relating to a position of the first viewer relative to the light detector, wherein the position includes proximity and aximuth angle relative to the light detector; and

a computer processor for transmitting video signals of the video image onto the video monitor, for receiving the electrical signals from the light detector, and for changing the field of view of the video image based on changes in position of the first viewer;

whereby, as the first viewer moves relative to the video monitor, corresponding changes to the video image are made by the computer processor to pan the video image based on changes to the first viewer's line of sight to the video monitor.

### BRIEF DESCRIPTION OF THE DRAWINGS

The invention will be described in greater detail with reference to the accompanying drawings which represent preferred embodiments thereof, wherein:

FIG. 1 is a schematic representation of the gesture recognition video display window, in accordance with the present invention;

FIG. 2 is a plan view of the light source and light detector of the device of FIG. 1;

FIGS. 3a and 3b are schematic representations of the device of FIG. 1 illustrating alternative images as the viewer moves from side to side;

FIG. 4 is a schematic representation of the device of FIG. 1 with the viewer in close proximity thereof; and

FIG. 5 is a schematic representation of the device of FIG. 1 with the viewer relatively far away therefrom.

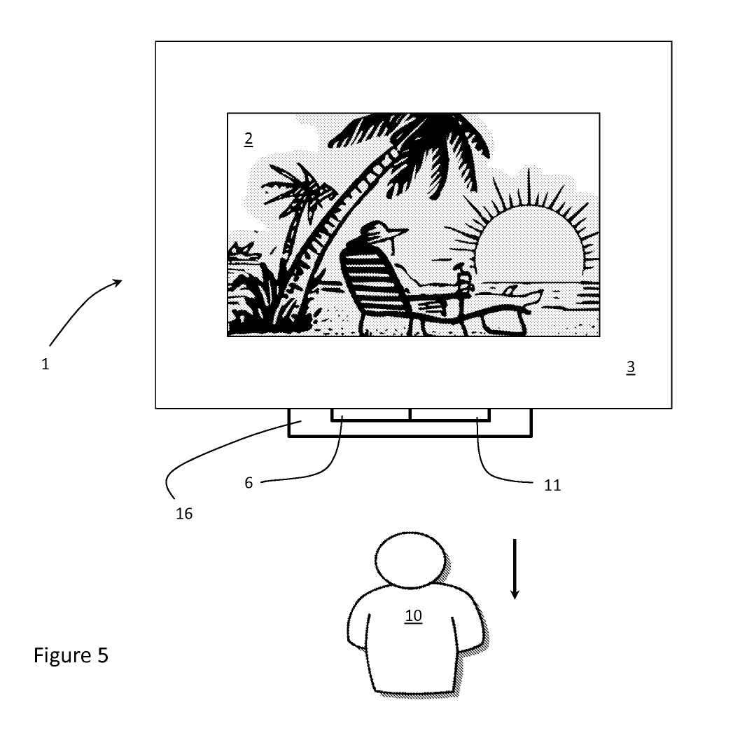

### DETAILED DESCRIPTION

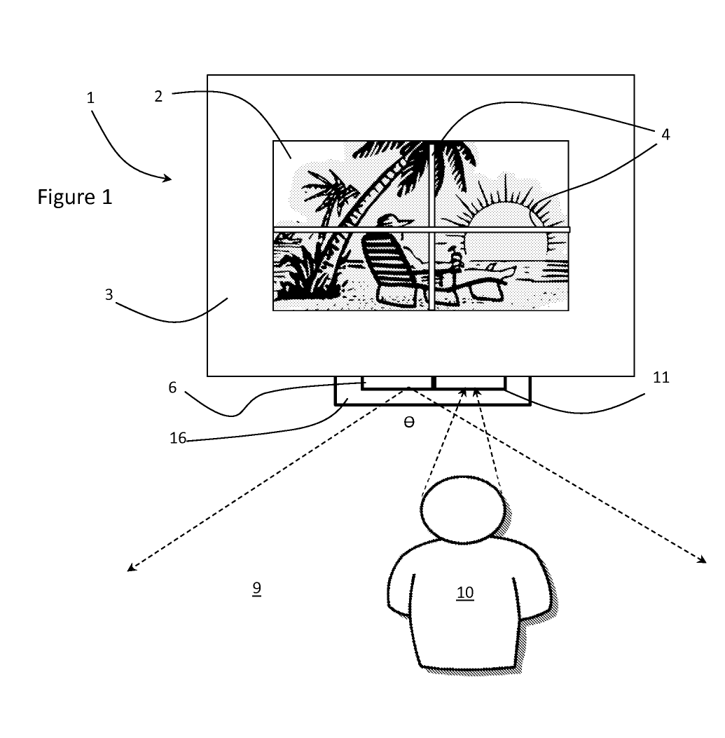

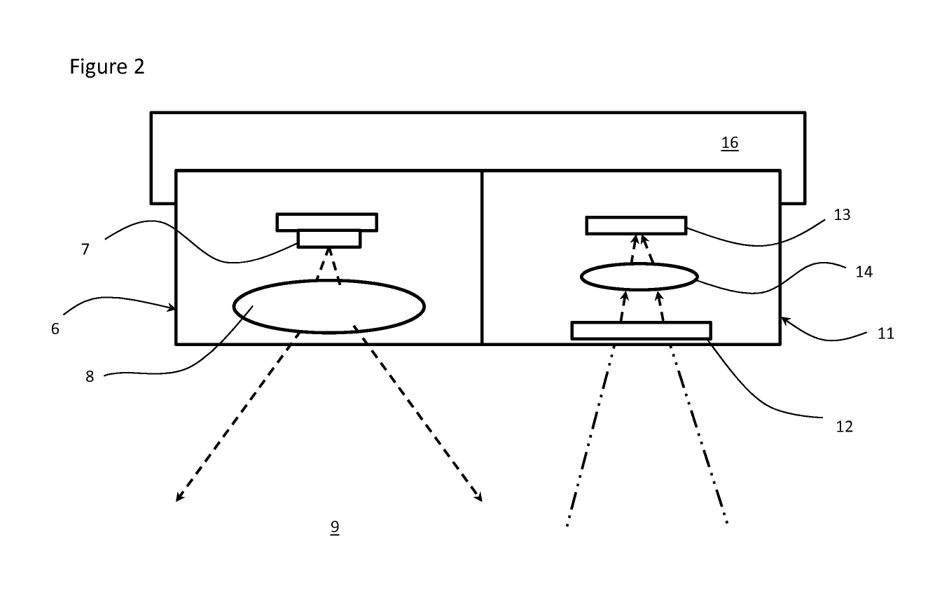

With reference to FIGS. 1 and 2, the video display picture 1 of the present invention includes a display screen 2, which can be a single flat screen display of any type, e.g. plasma, LCD, LCOS etc., or a plurality of interconnected smaller flat screen displays capable of combining to display essentially a single image. Ideally, the display screen includes an outer frame 3 and other inner framing 4 to make the display appear to have grids or muntins, i.e. to appear like a typical window to the outside.

An illuminating device 6, which includes a light source 7, such as an LED or laser diode, typically generates infrared or near-infrared light, which ideally isn't noticeable to users and is preferably optically modulated to improve the resolution performance of the system. Ideally, some form of controlling optics, e.g. optical lensing 8, help optimally illuminate a zone of illumination 9 in front of the display screen 2 at a desired illumination angle θ and desired range. The desired range is typically limited to minimize the number of users 10 within the range, and to minimize the cost of the light source 6 and optical lensing 8. A typical desired range is between 0 and 10 to 30 feet, preferably 0 to 20 feet.

Due to their inherent spectral precision and efficiency, diode lasers are a preferred option for the light source 7, particularly for high-volume consumer electronic applications, which are characterized by a limited source of electrical power and a high density of components, factors that drive a need to minimize dissipated thermal power.

The light sources 7 often work with other, wavelength-sensitive optical components, such as filters and detectors that require tight wavelength control over a wide temperature range. Moreover, for high data-rate systems, such as gesture recognition, the light sources 7 must operate with very low failure rates and with minimal degradation over time.

An optical receiver 11 includes a bandpass filter 12, which enables only reflected light that matches the illuminating light frequency to reach a light detector 13, thereby eliminating ambient and other stray light from inside the zone of illumination 9 that would degrade performance of the light detector 13. The optical filters 12 are sophisticated components in controlling optics for gesture recognition. Typically these are narrow bandpass near-infrared filters with very low signal-to-noise ratios in the desired band and thorough blocking elsewhere. Limiting the light that gets to the sensor eliminates unnecessary data unrelated to the gesture-recognition task at hand. This dramatically reduces the processing load on the firmware. As it is, noise-suppressing functionality is typically already coded into the application software.

Additional optical lensing 14 can also be provided in the optical receiver for focusing the reflected and filtered light onto the surface of the light detector 13.

The light detector 13 is a high performance optical receiver, which detects the reflected, filtered light and turns it into an electrical signal, i.e. a gesture code, for processing by a computer controller 16. The light detectors 13 used for gesture recognition are typically CMOS or CCD chips similar to those used in cell phones.

The computer controller 16, which ideally includes very-high-speed ASIC or DSP chips and suitable software stored on a non-transitory computer readable medium, reads data points from the light detector 13 and controls the image on the display screen 2. The computer controller 16 redisplays the video based on feedback from the gesture code, i.e. based on the relative position of the user 10 in front of the display screen 2. Accordingly, the computer controller 16 changes the image on the display screen 2, as the user 10 moves and the optical receiver 11 detects the movement. The computer controller 16 sends new display information to the monitor, so that the monitor seamlessly and in real time displays a video image to the monitor of what would be seen through a window, as the user 10 moves from side to side, closer or farther, up or down.

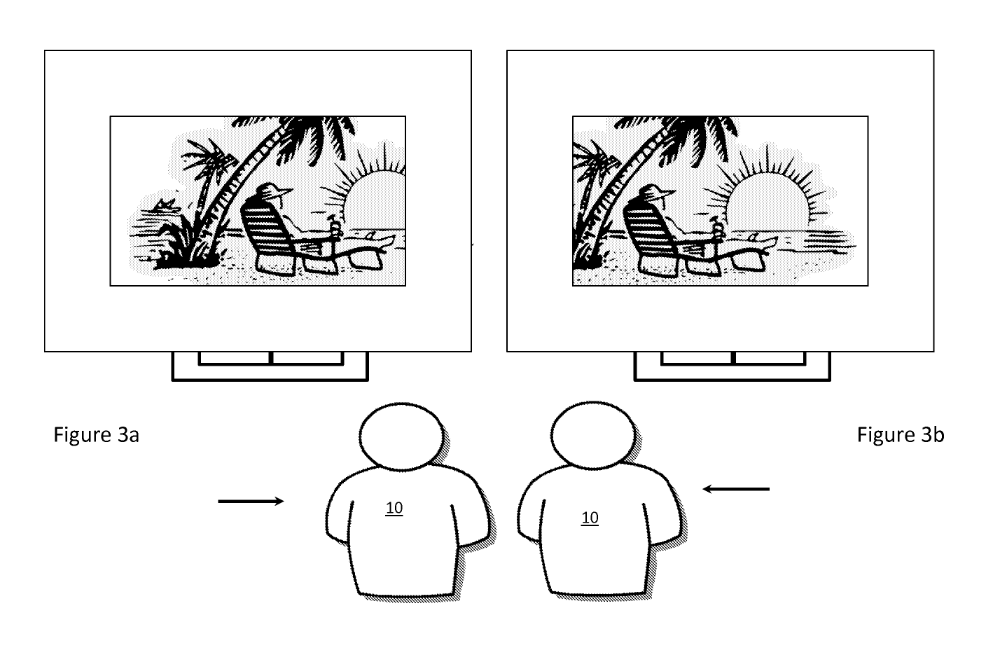

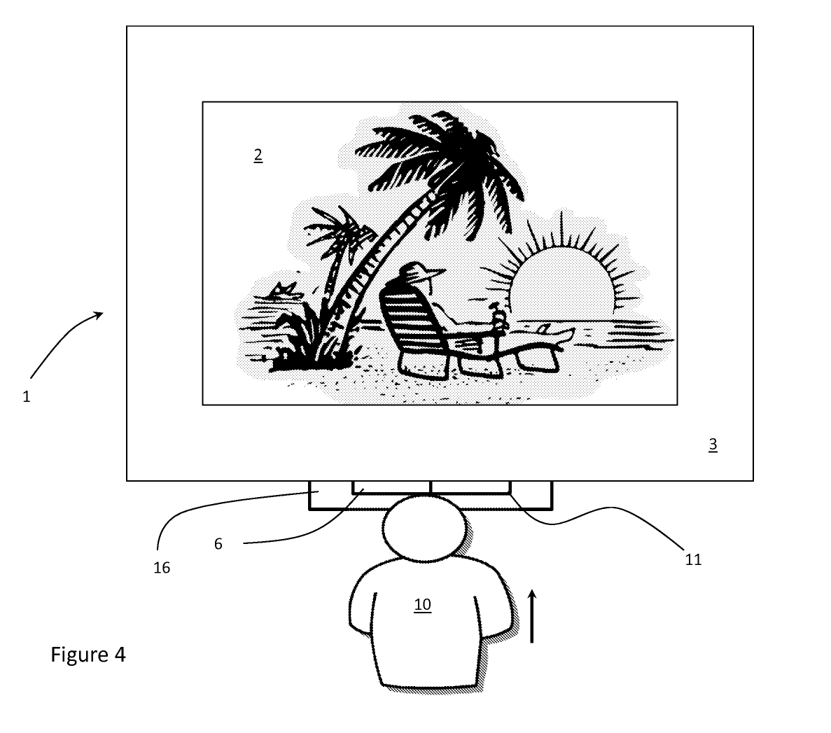

When the user 10 is stationary or in front of the image (see FIG. 1), the video broadcast by the computer controller 16 to user 10 on the display screen 2 would be as if the user 10 were staring straight out of a window. However, as the user 10 moves, the computer controller 16 identifies and tracks the head or body of the user 10 based on the gesture code from the light detector 13 to determine the position, e.g. proximity and azimuth, of the user 10 relative to the display screen 2, i.e. the light detector 13, and adjusts the image, i.e. the field of view, on the display screen 2 in real time as the head or body of the user 10 moves from one side to the other (FIGS. 3a and 3b), and if the head or body move closer or farther away (FIGS. 4a and 4b), i.e. as the user's perspective changes. With reference to FIGS. 3a as the user 10 moves to their right, the computer controller 16 tracks the movements, and displays more visual information of the left side of the video image on the display screen 2, while removing some of the right side of the video image, i.e. the portion of the video image that would be blocked from the user's line of sight by the right side of the window frame 3. With reference to FIG. 3b, when the user 10 moves to the left, the computer controller 16 continually tracks the movement, and pans the video image at the same speed as the user 10, and changes the image to displays additional visual information of the right side of the image on the display screen 2, while removing some of the left side of the video image, i.e. the portion of the video image blocked from the user's line of sight by the left side of the window frame 3.

With reference to FIG. 4a, as the user 10 moves closer to the display screen 2, the computer controller 16, tracks the movements of the user 10, taking cues from the gesture code from the light detector 13, and enlarges the video image's field of view to include more of the image at the top, bottom and two sides, i.e. to appear as if the field of vision has increased in both height and width dimensions. With reference to FIG. 4b, as the user 10 moves farther away from the display screen 2, the computer controller 16, tracks the movements of the user 10, and reduces the amount of the image displayed on the display screen 2 from both sides and the top and bottom, to make it appear as if the user 10 now has a diminished field of view.

Furthermore, if the user 10 crouches down or somehow becomes elevated, the computer controller 16 will also track those movements, and adjust the image on the display screen 2 to display additional portions of the image at the top and bottom, respectively, while eliminating existing portions of the image at the bottom and top, respectively.

If a second user enters into the zone of illumination 9, the computer controller 16 will identify the second user, but will ignore them with respect to adjusting the video image until the first user 10 leaves the zone 9. Alternatively, when the computer controller 16 identifies a second user within the zone 9, the computer controller 16 selects the user closer to the display screen 2, and tracks their movements for adjusting the image on the display screen 2.

The computer controller 16 also includes a non-transitory computer readable medium for storing data relating to a predetermined time, e.g. 24 hours, of each video image, including information relating to the video image seen from all possible distances, angle and elevations within the predetermined zone 9. The data base can also include data relating to a predetermined time, e.g. at least 1 hour, preferably up to 12 hours, more preferably up to 24 hours and most preferably up to 1 week, of a variety of different video images, e.g. beach, mountain, fish tank, city, etc., which can be set for display on the display screen 2 using some form of user interface, e.g. keyboard, touch screen etc.

We claim:

1. A gesture recognition video display device comprising:
a video monitor for displaying a video image;
a light source for launching a beam of light at a predetermined wavelength defining a zone of illumination;
a light detector for receiving light at the predetermined wavelength reflected from a first viewer within the zone of illumination, and for generating electrical signals relating to a position of the first viewer relative to the light detector, wherein the position includes proximity and aximuth angle relative to the light detector; and
a computer processor for transmitting video signals of the video image onto the video monitor, for receiving the electrical signals from the light detector, and for changing the field of view of the video image based on changes in position of the first viewer;
whereby, as the first viewer moves relative to the video monitor, corresponding changes to the video image are made by the computer processor to pan the video image based on changes to the first viewer's line of sight to the video monitor.

2. The device according to claim 1, wherein the computer processor tracks only the head or body of the first viewer to determine the position of the first viewer relative to the video monitor.

3. The device according to claim 1, wherein position also includes elevation relative to the light detector.

4. The device according to claim 1, further comprising:
a non-transitory computer readable medium including a database of different video images for display, each having for a predetermined length; and
a user interface for selecting which one of the different video images to display.

5. The device according to claim 3, wherein the predetermined length is at least 2 hours.

6. The device according to claim 3, wherein the predetermined length is at least 12 hours.

7. The device according to claim 3, wherein the predetermined length is at least 24 hours.

8. The device according to claim 1, wherein the light detector includes a bandpass filter for filtering out light not of the predetermined wavelength.

9. The device according to claim 1, wherein, when a second user enter the zone of illumination, the computer processor is programmed to change the video images based on the movements of the first user only, until the first user leaves the zone of illumination.

10. The device according to claim 1, further comprising an outer frame around the video monitor to make the video monitor appear like a window.
